(19) United States
(12) Patent Application Publication
(10) Pub. No.: US 2023/0009497 A1
(43) Pub. Date: Jan. 12, 2023

(54) METHOD FOR OPERATING AN ELECTRIC MACHINE

(71) Applicant: Robert Bosch GmbH, Stuttgart (DE)

(72) Inventors: Christian Freitag, Ditzingen-Heimerdingen (DE); Goekhan Tokgoez, Gersthofen (DE); Martin Viereckel, Illingen (DE)

(21) Appl. No.: 17/782,690

(22) PCT Filed: Nov. 17, 2020
(86) PCT No.: PCT/EP2020/082333

§ 371 Date: Jun. 6, 2022

(30) Foreign Application Priority Data
Dec. 6, 2019 (DE) 10 2019 219 034.0

(51) Int. Cl. H02P 27/08; H02P 23/14

(52) U.S. Cl. CPC H02P 27/08; H02P 23/14

(57) ABSTRACT

The invention relates to a method for operating an electric machine (100) having a stator having stator windings and a rotor, having a converter (110) and having a sensor (120) for detecting a measurement value, wherein the converter (110) has direct current connections, alternating current connections and semiconductor switches for connecting one of the direct current connections to one of the alternating current connections in each case, wherein the stator windings are connected to the alternating current connections, the semiconductor switches of the converter (110) being closed and opened at specific changeover times, a measurement being carried out by the sensor (120) at specific measurement times, the specific changeover times being adapted to the specific measurement times such that in a specific time interval about a specific measurement time the semiconductor switches are not closed and opened, and a control unit (150) and a computer program for carrying out said method.

### BACKGROUND OF THE INVENTION

The present invention relates to a method for operating an electric machine comprising a power converter and to a control unit and a computer program for carrying out said method.

Electric machines, in particular when used in a vehicle, can be motor-operated at a power converter, in particular an inverter, which is fed by a DC circuit. A conventional feature for such inverters, also referred to as traction inverters, is clocked opening and closing of switching elements, in particular semiconductor switches such as MOSFETs or IGBTs, for example by way of block commutation.

There is usually potential isolation between the drive electronics and the power converter. In 48 V systems, for example in what are known as boost recuperation machines (BRM), applications in which this potential isolation is not present for reasons of installation space and costs are conceivable.

However, an absent potential isolation leads to switching processes, that is to say the opening and closing of switching elements, being able to have an effect in potential jumps at the logic supply. For example, the measurement of the phase current and/or the measurement of the rotor position of the rotor of the electric machine can thus be impaired.

To remedy this, the measurement time can be calculated and adjusted variably depending on the switching processes. Particularly in the case of multiphase electric machines and increasing drive frequencies, the search for unimpaired measurement times is complex. Furthermore, negative aspects for the control on account of non-equidistant measurements and additional outlay for plausibility tests due to safety aspects according to ISO 26262 can arise here.

In the case of electric machines (or drives) in the automotive sector, the standard ISO 26262 is generally used, in which this so-called “Automotive Safety Integrity Level” (ASIL) is defined. For electric machines with an ASIL classification, the generated torque is generally assigned a safety load, i.e. the generated torque must have a preset accuracy.

For reasons of cost, the torque of an electric machine can be determined using measured phase currents and corresponding machine equations; a torque sensor is then not required. In this case, however, as accurate as possible a detection of the phase currents is important in order to meet the requirements of ISO 26262. The phase currents are generally used in the current regulation, by means of which a setpoint torque can be realized. Inaccurately detected phase currents therefore result in an inaccurately set torque, which in turn can result in the infringement of safety targets according to ISO 26262.

### SUMMARY OF THE INVENTION

The invention proposes a method for operating an electric machine comprising a power converter and a control unit and a computer program for carrying out said method, having the features of the independent patent claims. Advantageous configurations are the subject matter of the dependent claims and the description which follows.

The invention is based on the measure of achieving unimpaired and in particular equidistant measurements by virtue of the switchover times of the semiconductor switches being shifted where necessary.

In this case, the determined switchover times are adjusted to the determined measurement times in such a way that the semiconductor switches are not closed and opened in a determined interval around a determined measurement time. The interval may be in particular a time interval or a rotary angle interval (of the rotor).

This has the advantage that the measurement is not influenced or impaired by the sensor, for example by potential jumps at the logic supply. On the one hand, the interval is selected to be as long as possible so that the time is sufficient for the measurement but, on the other hand, is selected to be as short as possible so that the measurement does not unnecessarily delay the opening or the closing of the semiconductor switches. A time interval of 10 μs, in particular of 5 μs, is preferably used.

In a case in which a determined switchover time is in the determined interval around a determined measurement time, the determined switchover time is advantageously shifted to outside of the determined interval. This is advantageous because it prevents the measurement being influenced or impaired by the switching of the semiconductors. In this case, the determined switchover time can be shifted in such a way that the determined switchover time is shifted to the last possible time before the interval or to the earliest possible time after the interval. This may also depend on the position of the switchover time in the interval, that is to say if it is closer to the beginning or to the end.

Preferably, a switchover time of a first semiconductor switch (in particular high side) of a branch of the power converter is shifted before the time interval and a switchover time of a second semiconductor switch (in particular low side) of the branch of the power converter is shifted after the time interval. The shift furthermore preferably takes place symmetrically to the actual switching time. In this way, the occurrence of torque fluctuations (ripple) can be prevented.

The determined measurement times are advantageously equidistant in time. The measurements are therefore carried out at regular time intervals. Measurement values that are equidistant in time can therefore be obtained in order to meet the requirements mentioned at the beginning, for example.

The sensor is advantageously used to measure a phase current flowing through one of the stator windings or a rotor position of the rotor. The phase current can be measured for example by means of what are known as shunts. In general, these shunts are not installed directly in the phases of the stator windings but for example in a low-side path and/or in the high-side path of the power converter.

If the shunts are installed only in the low-side path, the phase current can be measured only when the low-side path is switched on. The same applies to the high-side path.

The stator winding is advantageously operated in block commutation. From a determined speed, what is known as the transition speed, the electric machine reaches what is known as the voltage limit. At said voltage limit, the synchronous internal voltage produced is greater than the voltage applied to the phases. In order that the machine can produce a motor torque above this speed, the machine is operated in what is known as field-weakening operation. However, since this mode of operation has a lower efficiency, the transition speed should be as high as possible, which can be achieved for example by way of a higher phase voltage. Corresponding machines are therefore controlled in the field-weakening range in block operation, since a greater effective voltage can be produced therein at the stator winding than in PWM control.

In block commutation, no fixed control frequency (that is to say no PWM commutation) is used but instead the semiconductor switches are switched on and off in a blocked manner in synchronization with the electrical angular velocity of the electric machine. Various block widths can be realized depending on the phase number. The type of control that produces the greatest effective phase voltage is so-called 180° block commutation, in which the high-side and low-side semiconductor switches are each switched on for an electrical angle of 180° for each phase within one electrical revolution.

The determined switchover times and the determined measurement times are advantageously determined by a control unit. The control unit calculates or determines the measurement times first, for example. The control unit then calculates or determines the switchover times of the semiconductor switches and compares the determined measurement times with the determined switchover times. If a determined switchover time is in an interval around a determined measurement time, the control unit determines whether the switchover time is shifted to a time before or to a time after the interval.

Furthermore, the control unit according to the invention, for example a control device of a motor vehicle, is set up to carry out a method according to the invention.

The implementation of a method according to the invention in the form of a computer program or computer program product comprising program code means for carrying out all of the method steps is also advantageous since this incurs particularly low costs, in particular when an executing control device is also being used for other tasks and is therefore present in any case. Suitable data carriers for providing the computer program are in particular magnetic, optical and electrical storage devices, such as, for example, hard disks, flash memories, EEPROMs, DVDs and many more. A download of a program over computer networks (Internet, intranet, etc.) is also possible.

### BRIEF DESCRIPTION OF THE DRAWINGS

Further advantages and configurations of the invention result from the description and the attached drawing.

The invention is illustrated schematically using an exemplary embodiment in the drawing and will be described below with reference to the drawing.

FIG. 1 schematically shows an electric machine comprising power converter in which a method according to the invention can be carried out.

FIG. 2 schematically shows a sequence of a method according to the invention in a preferred embodiment.

### DETAILED DESCRIPTION

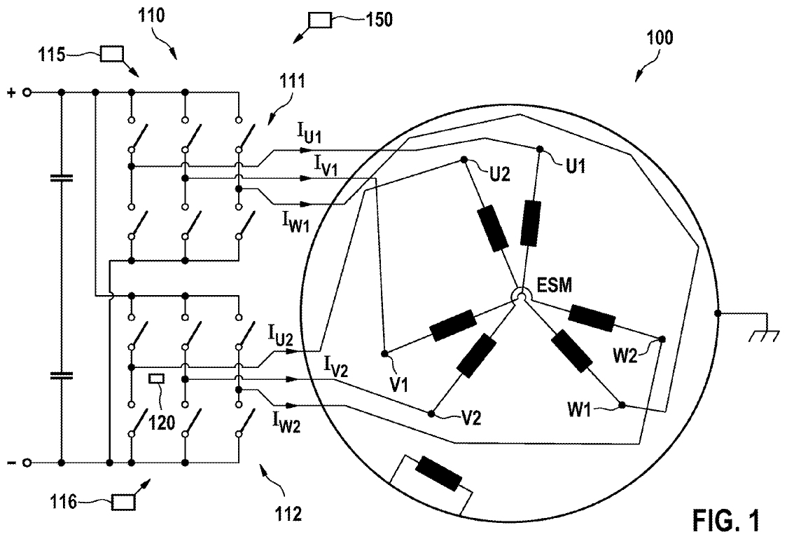

FIG. 1 schematically illustrates an electric machine 100 comprising a power converter 110, in which electric machine a method according to the invention can be carried out. The electric machine has (in a stator which is not illustrated) six phases (phase windings), which form two three-phase current groups as subsystems and are denoted by U1, V1 and W1, and U2, V2 and W2. In this case, for example, there is an electrical phase shift of 30° between the two three-phase subsystems U1, V1, W1 and U2, V2, W2. A three-phase current group is characterized by an electrical connection of the phase windings in the stator, in this case, for example, a common neutral point, but is not electrically connected to phases of other three-phase current groups in the stator and can therefore have a dedicated drive scheme, which, in principle, can be different than drive schemes of other three-phase current groups.

The power converter 110 has two parts 111 and 112, which are each in the form of conventional bridge rectifiers, have six switching elements (not denoted in detail), for example semiconductor switches such as MOSFETs, and each serve to drive one of the three-phase subsystems U1, V1, W1 or U2, V2, W2 (i.e. to connect it to the DC voltage terminals of the power converter). The power converter 110 is interconnected with a positive and a negative terminal, for example into a vehicle power supply system of a vehicle as DC voltage terminals, via two capacitors (not denoted in detail). In addition, by way of example, an open-loop and/or closed-loop control unit 150 is shown, which is used for driving the power converter 110, in particular for opening and closing the switching elements. It goes without saying that such a control unit can also be integrated in the power converter 110.

The driving of the two three-phase subsystems U1, V1, W1 and U2, V2, W2 in this case takes place via two separate drive circuits 115 and 116. In this case in each case one phase current I_{U1}, I_{V1} and I_{W1} or I_{U2}, I_{V2} and I_{W2} flows through the phases. These phase currents can be measured or detected, for example, by means of a phase current sensor or a current-measuring device—one such device is denoted schematically and by way of example by 120.

When there is no potential isolation between the drive circuits 115 and 116 and the power converter 110, switching processes, that is to say the opening and closing of switching elements, can result in potential jumps at the logic supply. For example, the measurement of the phase current of the electric machine 100 can thus be impaired.

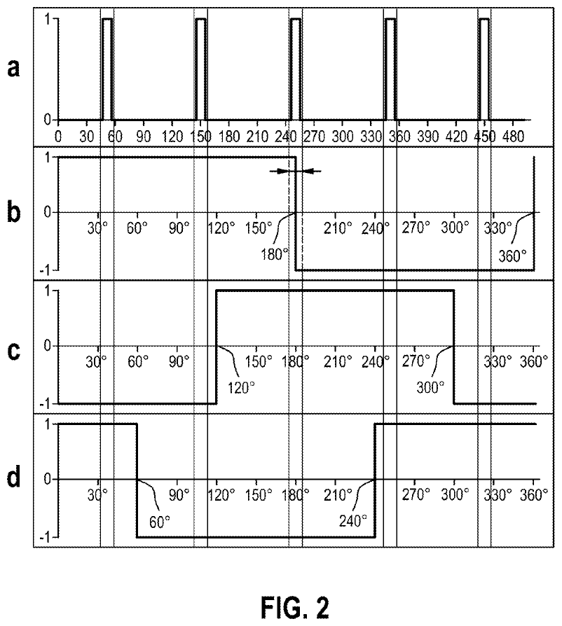

FIG. 2 schematically shows a sequence of a method according to the invention in a preferred embodiment. In this regard, the electric machine 100 comprising the power converter 110 can be used as shown in FIG. 1. For simplification, only one of the two three-phase subsystems U1, V1, W1 is illustrated, which is operated here in 180° block commutation.

Graph 2a of FIG. 2 shows determined time intervals around determined measurement times of the measurement of the phase current. For example, respective measurements take place here at the times 50 μs, 150 μs, 250 μs, 350 μs and 450 μs. Overall, therefore, five measurements (for the present speed) are carried out during a full revolution of the rotor. There is an equidistant interval of 100 μs between the determined measurement times. The time interval around a determined measurement time is in this case 10 μs, with the time interval beginning 5 μs before a determined measurement time and ending 5 μs after a determined measurement time (see arrow). The time interval around the determined measurement time 250 μs thus begins at time 245 μs and ends at time 255 μs.

Graphs 2b to 2d show each of the determined switchover times, that is to say the time of switch-on and switch-off, of the individual phases U1, V1 and W1. A switched-on (on) high-side FET and a switched-off (off) low-side FET is represented here by the value 1; a switched-on low-side FET and a switched-off high-side FET is represented by the value −1. At a switchover time, both switching elements associated with a phase are therefore usually always switched over. In this case, it should expediently be noted that there is no short circuit, that is to say one switching element is always off. If both switches are switched off, this is represented by the value 0.

While the measurements take place without interference at the times 50 μs, 150 μs, 350 μs, 450 μs, that is to say without a simultaneous switching process being carried out, a measurement of the phase current at time 250 μs would collide with a switchover time of phase U1, that is to say switch-off of the high-side FET and switch-on of the low-side FET of phase U1.

The high-side FET is therefore already switched off at time 245 μs, which constitutes the last possible time before the time interval around the determined measurement time at 250 μs. Furthermore, the low-side FET is not switched on at time 250 μs but only at time 255 μs, which constitutes the earliest possible time after the time interval around the determined measurement time at 250 μs. In this case, however, the length of the available voltage vector is reduced. As an alternative, the shift of the switchover times can also be effected depending on angle, that is to say for example at 175° and 185°. It is understood, however, that both the high-side FET and the low-side FET can be switched together before or after the interval. As a result, however, the control angle changes, as a result of which a torque ripple arises.

The calculation of the determined measurement times and the determined switchover times is carried out here by the control unit 150 (see FIG. 1). In addition, the control unit 150 determines whether a determined switchover time is in the determined interval around a determined measurement time and shifts the switchover time if required.

1. A method for operating an electric machine (100) including a stator that has stator windings, a rotor, a power converter (110), and a sensor (120) for detecting a measurement variable,
wherein the power converter (110) has DC terminals, AC terminals, and semiconductor switches for connecting each one of the DC terminals to one of the AC terminals, wherein the stator windings are connected to the AC terminals, the method comprising:
closing and opening the semiconductor switches of the power converter (110) at determined switchover times,
carrying out a respective measurement via the sensor (120) at determined measurement times, and
adjusting the determined switchover times to the determined measurement times in such a way that the semiconductor switches are not closed and opened in a determined interval around a determined measurement time.

2. The method as claimed in claim 1, wherein, in a case in which a determined switchover time is in the determined interval around a determined measurement time, the determined switchover time is shifted to outside of the determined time interval.

3. The method as claimed in claim 2, wherein a switchover time of a first semiconductor switch of a branch of the power converter (110) is shifted before the time interval and a switchover time of a second semiconductor switch of the branch of the power converter (110) is shifted after the time interval.

4. The method as claimed in claim 1, wherein the determined measurement times are equidistant in time.

5. The method as claimed in claim 1, wherein the sensor (120) is used to measure a phase current flowing through one of the stator windings or a rotor position of the rotor.

6. The method as claimed in claim 1, wherein the stator windings are operated in block commutation.

7. The method as claimed in claim 1, wherein the determined switchover times and the determined measurement times are determined by a control unit (150).

8. A control unit (150), which is set up to carry out all of the method steps of a method as claimed in claim 1.

9. (canceled)

10. A non-transitory, computer readable medium containing instructions that when executed by a computer cause the computer to operate an electric machine (100) including a stator that has stator windings, a rotor, a power converter (110), and a sensor (120) for detecting a measurement variable,
wherein the power converter (110) has DC terminals, AC terminals, and semiconductor switches for connecting each one of the DC terminals to one of the AC terminals, wherein the stator windings are connected to the AC terminals, by controlling:
closing and opening the semiconductor switches of the power converter (110) at determined switchover times,
respective measurement via the sensor (120) at determined measurement times, and
adjustment of the determined switchover times to the determined measurement times in such a way that the semiconductor switches are not closed and opened in a determined interval around a determined measurement time.
